(19) United States
(12) Patent Application Publication
(10) Pub. No.: US 2006/0140541 A1
(43) Pub. Date: Jun. 29, 2006

(54) Integrated optical device

(76) Inventors: Giacomo Gorni, Pavia (IT); Marco Romagnoli, Milano (IT); Riccardo Tediosi, Pavia (IT); Daniele Faccio, Como (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/529,223

(22) PCT Filed: Sep. 27, 2002
(86) PCT No.: PCT/EP02/10896

§ 371 Date: Nov. 21, 2005

(51) Int. Cl. G02B 6/26

(52) U.S. Cl. 385/50

(57) ABSTRACT

An integrated optical device having a first and a second integrated waveguide; a section of the first waveguide and a section of the second waveguide arranged so as to be in optical coupling relationship. A first and a second modulated refractive index structures are respectively formed along the first waveguide section and the second waveguide section. Each modulated refractive index structure has at least one pair of regions of mutually different refractive index, adjacent to each other along the respective waveguide section. The regions of mutually different refractive index have a portion of the respective waveguide section and a gap formed in the waveguide section. The refractive indexes of the regions differ from each other by least approximately 1.5%. The device can be used for optical multiplexers/demultiplexers, particularly for wavelength division multiplexing optical communications.

The present invention generally relates to the field of integrated optics, and particularly to integrated optical devices for Wavelength Division Multiplexing (WDM) optical communication systems. More specifically, the present invention relates to an integrated multiplexer/demultiplexer optical device, for dropping and/or adding optical signals from/to a wavelength division multiplexed optical signal (Optical Add-Drop Multiplexer—shortly OADM).

In WDM optical communications, a plurality of mutually independent optical signals are multiplexed in the optical wavelength domain and sent along a line, comprising optical fibers or integrated waveguides; the signals can be either digital or analogue, and they are distinguished from each other in that each of them has a specific wavelength, distinct from those of the other signals.

In the practice, specific wavelength bands of predetermined amplitude, also referred to as channels, are assigned to each of the signals at different wavelengths. The channels, each identified by a respective wavelength value called the channel central wavelength, have a certain spectral amplitude around the central wavelength value, which depends, in particular, on the characteristics of the signal source laser and on the modulation imparted thereto for associating an information content with the signal. Typical values of spectral separation between adjacent channels are 1.6 nm and 0.8 nm for the so-called Dense WDM (shortly, DWDM), and 20 nm for Coarse WDM (CWDM—ITU Recommendation No. G.694.2).

Currently, signal processing (multiplexing, demultiplexing, routing) is mainly performed on electrical signals, by means of electronic devices. Optical-electrical-optical conversion of the signals is therefore required. This constitutes the main bottleneck against the increase in the communication band.

Efforts are therefore being made for developing optical devices that are capable of processing the signals directly in the optical domain.

In particular, optical devices (optical demultiplexers), are required that are capable of separating the different channels of a wavelength division multiplexed optical signal travelling on a line, and routing the individual channels to the desired recipients. Similarly, optical devices (optical multiplexers) are necessary for receiving separate channels from distinct sources and combining them into a wavelength division multiplexed signal.

A known technique for realizing this kind of optical devices exploits Bragg filters, i.e., optical filters obtained by means of Bragg gratings, essentially consisting of alternated regions of different refractive index; when an optical signal is propagated through the filter, some wavelengths are reflected, some others pass through the filter, depending on the grating structure.

Integrated add/drop multiplexing devices are known comprising directional couplers with Bragg gratings realized in the optical coupling region. One such device is for example described in D. Mechin et al., “Add-Drop Multiplexer With UV-Written Bragg Gratings and Directional Coupler in SiO₂—Si Integrated Waveguides”, Journal of Lightwave Technology, Vol. 19, September 2001, pages 1282-1286.

The Applicant observes that this device is a low refractive index contrast device.

For the purposes of the present invention, with grating with a “low refractive index contrast” it is intended a grating wherein the percentage difference Δn=100×(n₂/n₁−1) [%] between the refractive indexes n₁ and n₂ of the regions of different refractive index (n₁ being the lower value) is lower than 1.5%. Accordingly, in the following of the present description, with “high refractive index contrast” it will be intended a percentage difference greater of 1.5%.

The Applicant has observed that gratings having low refractive index contrast are adapted to reflect signals in a relatively small wavelength band (the signals with wavelengths outside this band are transmitted), and are not suitable for CWDM communications, where the width of each channel is relatively large. In addition to this, low refractive index contrast Bragg gratings have a significant length (the number of alternated regions must be high), which is in contrast with current trend towards high integration.

Compared to low refractive index contrast Bragg filters, high refractive index contrast Bragg filters allow obtaining a wider band of reflected wavelengths and a higher reflectivity with a significantly lower number of pairs of alternated regions of different refractive indexes. High refractive index contrast Bragg filters can thus be made more compact than their low refractive index contrast counterparts.

A different type of integrated multiplexing device is described in U.S. Pat. No. 4,790,614. This device exploits a monolithic optical filter obtained by forming in an optical waveguide a plurality of gaps, arranged in the light propagation direction, having period and width equal to multiples of a quarter of wavelength of the propagating signal, and a depth larger than the thickness of the waveguide core. The gaps are filled with a material having a refractive index different from that of the waveguide. The optical filter is designed so as to reflect or transmit the light thereon or therethrough depending on the wavelength characteristics thereof. Light-emitting semiconductor devices or photodetectors are formed monolithically on the light-transmitting and reflecting sides of the waveguide.

The Applicant has observed that using the technique disclosed in that document, high refractive index contrast Bragg gratings can be formed. Two types of Bragg gratings are disclosed in that document: a first type of grating is adapted to create an optical filter having a relatively wide reflection band; a second grating type is intended to create an optical filter having a relatively wide reflection band and, within the reflection band, a transmission band.

In particular, the Applicant has noted that this second type of gratings, intended to create optical filters capable of transmitting a selected range of wavelengths (pass band) within a relatively wide range of reflected wavelengths (stop band), actually cannot be practically exploited in the above-described field of optical communications, due to the very poor pass band characteristics.

In addition to this, the Applicant has observed that the different embodiments of multiplex device disclosed in that document are affected by problems due to the fact that, in order to be able to separate and properly route different channels of a wavelength division multiplexed optical signal, the direction of propagation of the signal must be tilted with respect to a direction perpendicular to the grating axis (defined by a direction perpendicular to the interfaces between regions of different refractive indexes, i.e. the walls of the gaps forming the optical filter). In other words, the angle of incidence of the optical signal onto the grating that forms the optical filter must be different from zero.

In particular, the Applicant has found that this causes a degrade in the optical filter performance, reducing the effective bandwidth and reducing the slope of the transition between the reflective and the transmissive bands. Additionally, the transversal width of the reflected optical beam is widened, causing a loss of power in the reflected signal.

The Applicant has found that an integrated optical coupler comprising, on each of the coupled waveguides, a grating that is formed by realizing gaps on the entire cross-section of the core of the waveguide and having a percentace variation of the refractive index of at least 1.5%, is adapted to realize optical multiplexers/demultiplexers, particularly for the use in WDM communications, and is not affected by the problems of the known devices. The grating structure may advantageoulsy be realized with a still higher refractive index contrast, preferably higher than 10%, more preferably higher than 50%, which provides a spectral response more suitable for the here-considered WDM applications.

The proposed device is compact, allows separating different channels of a wavelength division multiplexed signal and has an angle of incidence of the optical signals onto the optical filters that is equal to zero.

According to an aspect of the present invention, there is provided an integrated optical device as set forth in claim 1.

The integrated optical device of the present invention comprises a first and a second integrated waveguides each comprising a core and a cladding, having respective waveguide sections arranged so as to be in optical coupling relationship.

A first and a second modulated refractive index structures are respectively formed along the optically coupled sections of the first and second waveguides; each modulated refractive index structure comprises at least one pair of regions having a first refractive index n₁ and, respectively, a second refractive index n₂ greater than the first, said regions being adjacent to each other along the respective waveguide section. Said regions comprise a portion of the respective waveguide section and a gap extending at least across the entire cross-section of the core of the respective waveguide section, the percentage difference Δn=100×(n₂/n₁−1) [%] between said first and second refractive indexes being greater than 1.5%.

Preferably, the percentage difference is greater than 10%, more preferably greater than 50%.

An interface between the regions of mutually different refractive index is arranged orthogonally to the light propagation direction in the respective uncoupled waveguide section. The problems inherent to tilted directions of incidence of the light onto the modulated refractive index structures are avoided.

The first and second modulated refractive index structures may each comprise a plurality of pairs of regions of mutually different refractive index, arranged in succession along the respective waveguide section.

In an embodiment of the invention, at least one of said plurality of pairs of regions is a transmissive pair, adapted to transmitting optical signals with wavelengths within a prescribed wavelength pass band; the remaining pairs of regions are reflective pairs, adapted to reflect optical signals with wavelengths within a prescribed wavelength stop band containing the pass band. In particular, the pass band may correspond to at least one prescribed channel of a wavelength division multiplexed signal, and the stop band is at least as wide as an overall band occupied by the wavelength division multiplexed signal.

In a preferred embodiment of the invention, two or more transmissive pairs are distributed among the reflective pairs. The Applicant has found that this allows obtaining a relatively flat pass band.

All the transmissive pairs may have a same optical length, or they may have variable optical lengths in the light propagation direction. The Applicant has found that in order to achieve an even flatter pass band, in the first case a number of reflective pairs between adjacent transmissive pairs preferably varies along the respective waveguide section; in the second case, the number of reflective pairs between adjacent transmissive pairs may be kept constant or be varied along the respective waveguide section.

Preferably, the optically coupled waveguide sections of the first and second waveguides have a length such that an optical signal propagating through a first one of the two waveguides is substantially completely transferred to the second waveguide. Each one of the first and second modulated refractive index structures is preferably positioned along the respective waveguide sections in such a way that an equivalent mirror thereof is located substantially at a position where a factor of optical coupling between the optically coupled waveguide sections is approximately equal to 50%. The meaning of “equivalent mirror” will be explained in the following.

In particular, the first waveguide has a first input section, adjacent a first side of the optically coupled waveguide sections, and the second waveguide has a first and a second output sections, respectively adjacent a second side and the first side of the optically coupled waveguide sections. An input wavelength division multiplexed optical signal, including a first optical signal with wavelength in said pass band and entering the device through said first input section, is separated into a first output signal, corresponding to said first optical signal, and a second output signal, corresponding to the input wavelength division multiplexed optical signal deprived of the first optical signal; the first and second output signals respectively exit the device through the first and second output sections. The device is thus adapted to be used as an optical drop device.

The first waveguide may further comprise a second input section, adjacent the second side of the optically coupled. waveguide sections; a second optical signal with wavelength in said pass band and entering the device through said second input section propagates through the device to the second output section. The device is thus adapted to be used as an optical add/drop device.

According to a second aspect of the present invention, there is provided an integrated optical multiplexer/demultiplexer device as set forth in claim 13.

Summarising, the integrated optical multiplexer/demultiplexer device comprises at least a first and a second integrated optical devices, in which one among the first and second output sections of the first integrated optical device is connected to one among the first and second input section of the second integrated optical device.

In particular, the second output section of the first integrated optical device may be connected to the first input section of the second integrated optical device, and the first and second integrated optical devices may have differentiated first and second pass bands, corresponding to respective first and second channels of a wavelength division multiplexed optical.

The integrated optical multiplexer/demultiplexer device may comprise a first integrated optical device adapted to separating an input wavelength division multiplexed optical signal into two groups of channels adjacent to each other in the wavelength domain, at least one second integrated optical device adapted to extracting a signal in a respective channel of a respective one of the two channel groups and adding a new signal in the same channel as the extracted signal, and a third integrated optical device for recombining the two channel groups.

In another embodiment of integrated optical multiplexer/demultiplexer device according to the invention, the first output section of the first integrated optical device is connected to the first input section of the second integrated optical device, and the second input section of the first integrated optical device is connected to the second output section of the second integrated optical device, and a tuning device is provided for varying in a controlled way a pass band of the second integrated optical device in a wavelength range containing a pass band of the first integrated optical device.

According to still another aspect of the present invention, there is provided a process for manufacturing an integrated optical device as set forth in claim 17.

In brief, the process comprises:

forming on a substrate at least a first and a second integrated waveguides each comprising a core and a cladding, a section of the first waveguide and a section of the second waveguide being arranged so as to be in optical coupling relationship; and

forming along the first waveguide section and the second waveguide section at least one respective first and second modulated refractive index regions, comprising each at least one pair of regions of mutually different refractive index, adjacent to each other along the respective waveguide section.

The at least one pair of regions are formed by cutting away a portion of the respective waveguide section for defining a gap between two adjacent portions of the respective waveguide section, said gap extending for at least the entire cross-section of the core of the respective waveguide section; a refractive index of the gap is made different from a refractive index of the waveguide section of at least approximately 1.5%.

In particular, said cutting away is performed simultaneously in the first and second waveguide sections, for example using a mask defining a pattern of cuts to be formed in the first and second waveguide sections, and selectively removing the first and second waveguide sections according to the pattern defined by the mask.

The gaps may be filled with a substance having a refractive index different from that of the waveguide sections, such as air, or be vacuum emptied.

The features and advantages of the present invention will be made apparent by the following detailed description of some embodiments thereof, provided merely by way of non-limitative examples, which will be made referring to the attached drawings, wherein:

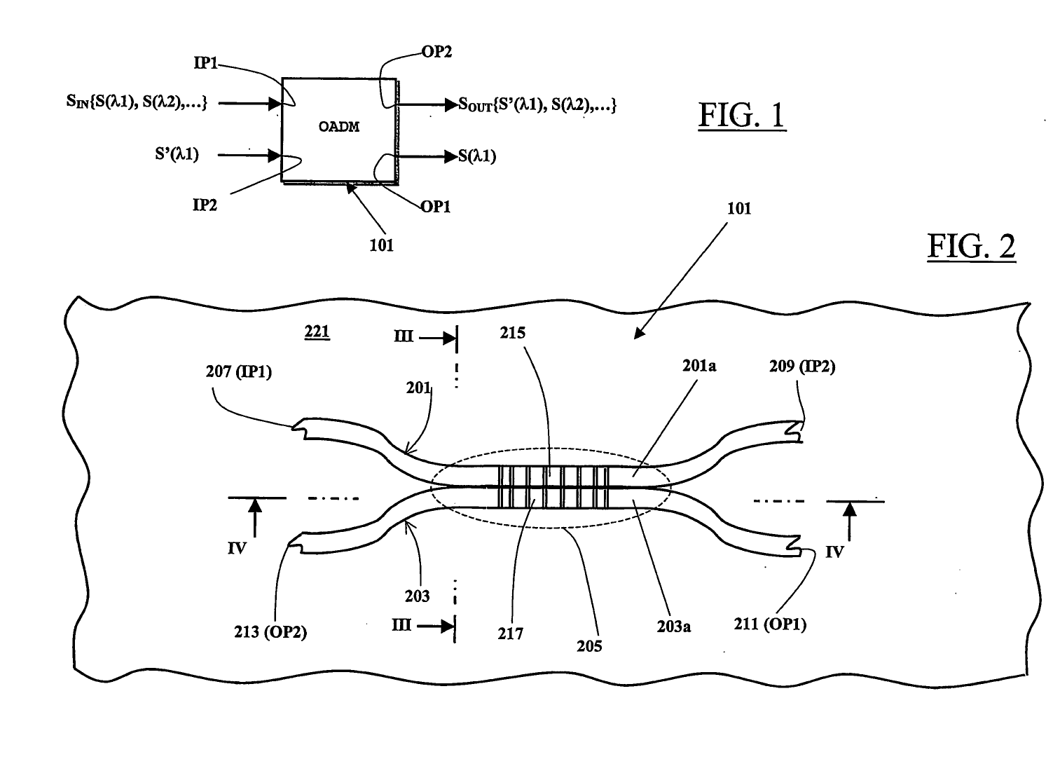

FIG. 1 is a symbolic representation of a single-channel optical add/drop device;

FIG. 2 is a schematic view of the optical add/drop device of FIG. 1 realized according to an embodiment of the present invention;

FIG. 3 is a cross-sectional view along the plane III-III in FIG. 2;

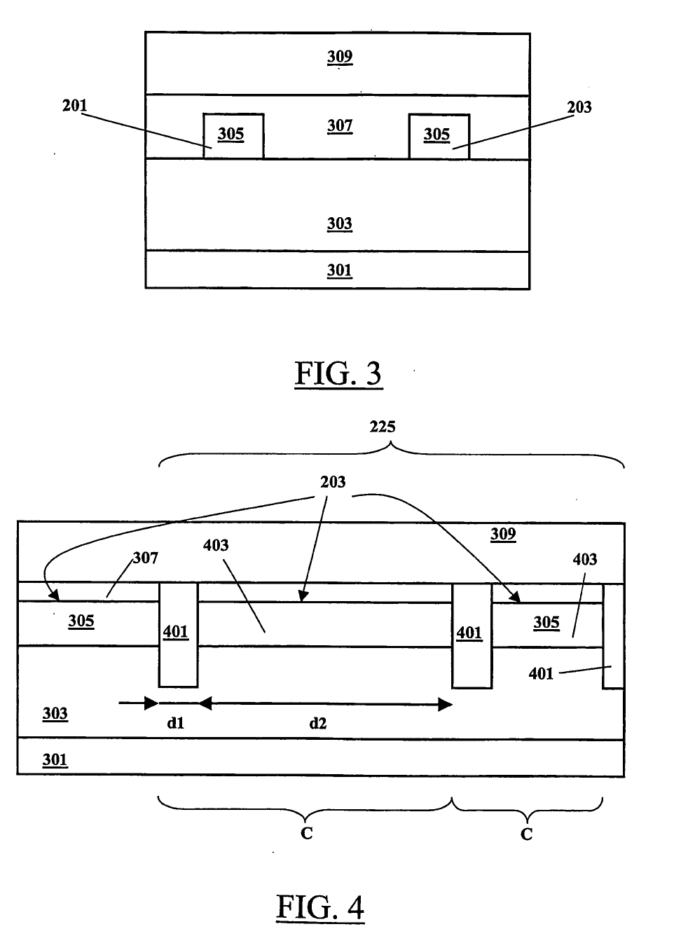

FIG. 4 is a cross-sectional view along the plane IV-IV in FIG. 2, showing a portion of a Bragg grating formed in the device of FIG. 2;

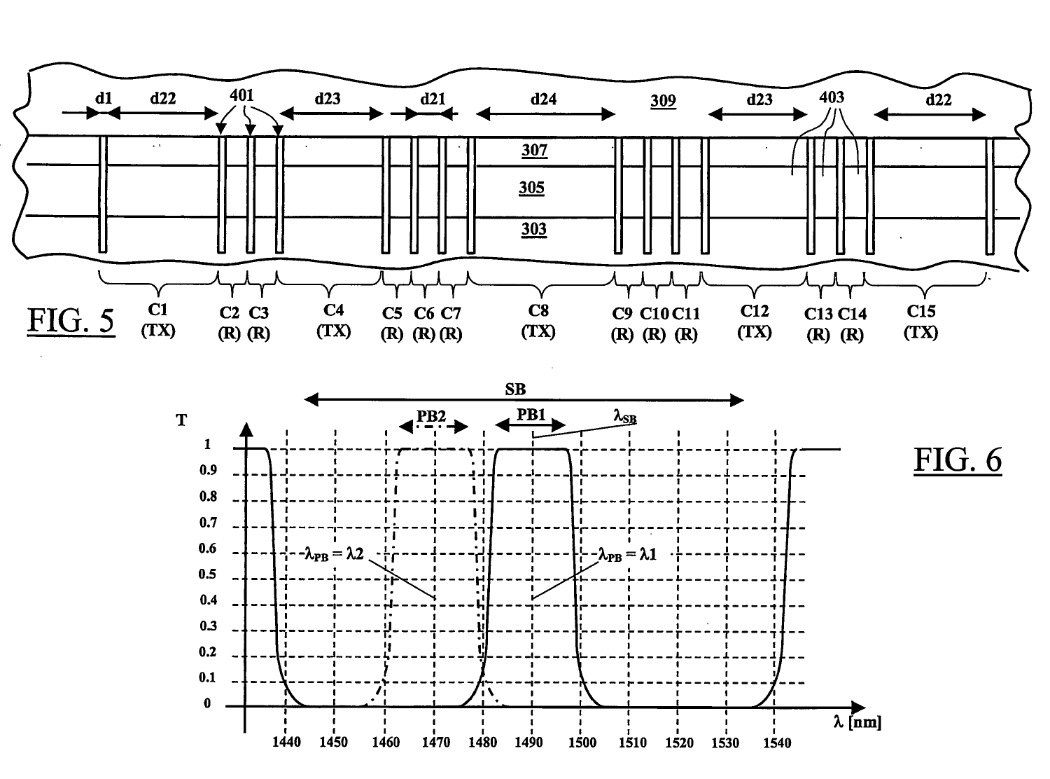

FIG. 5 schematically shows, in cross-sectional view similar to that of FIG. 4, a complete Bragg grating structure according to an embodiment of the present invention;

FIG. 6 shows in diagrammatic form an optical response of the Bragg grating of FIG. 5;

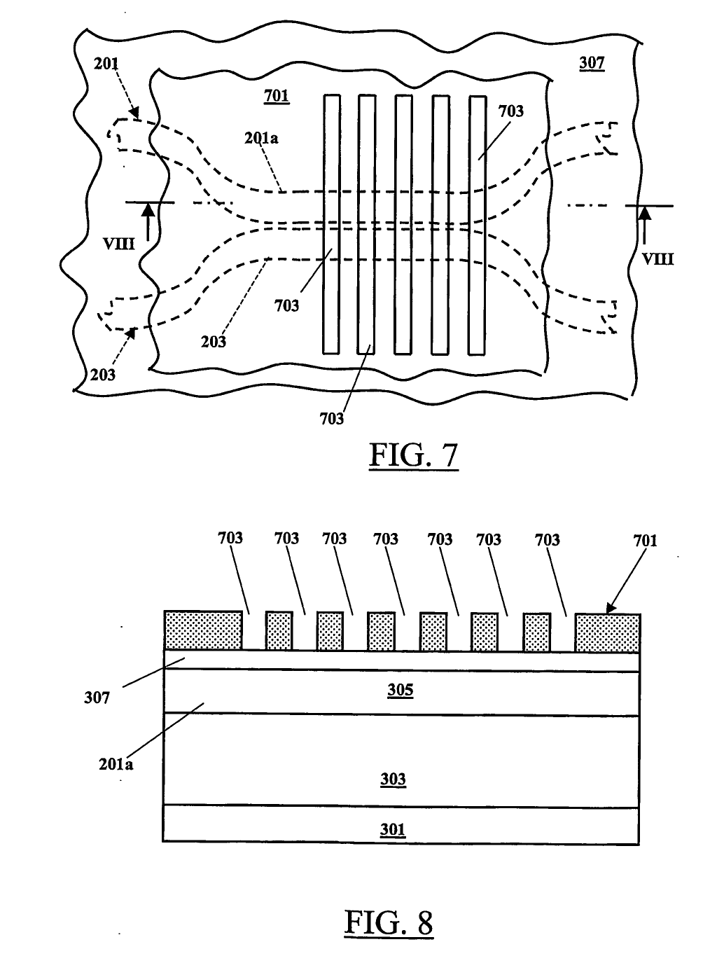

FIGS. 7 and 8 schematically show, respectively in top plan view and in cross-section along the plane VIII-VIII, the device of FIG. 2 at an intermediate step of a manufacturing process according to an embodiment of the present invention;

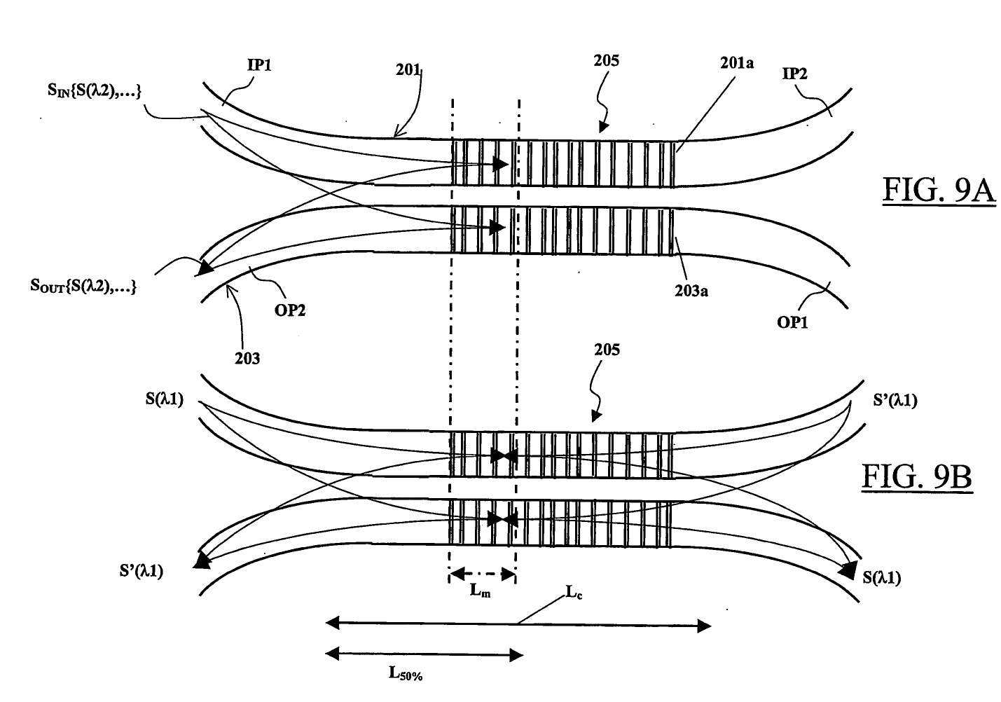

FIGS. 9A and 9B schematically show the operation of the optical add/drop device of FIG. 2;

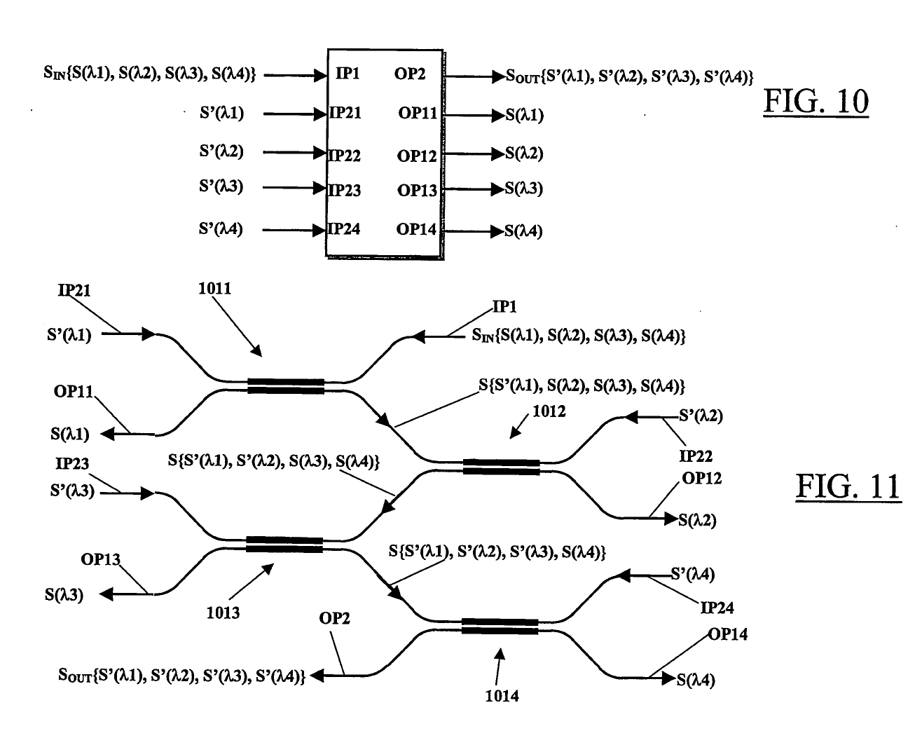

FIG. 10 is a symbolic representation of a four-channel optical add-drop device;

FIG. 11 is a schematic view of the four-channel optical add/drop device realized according to an embodiment of the present invention;

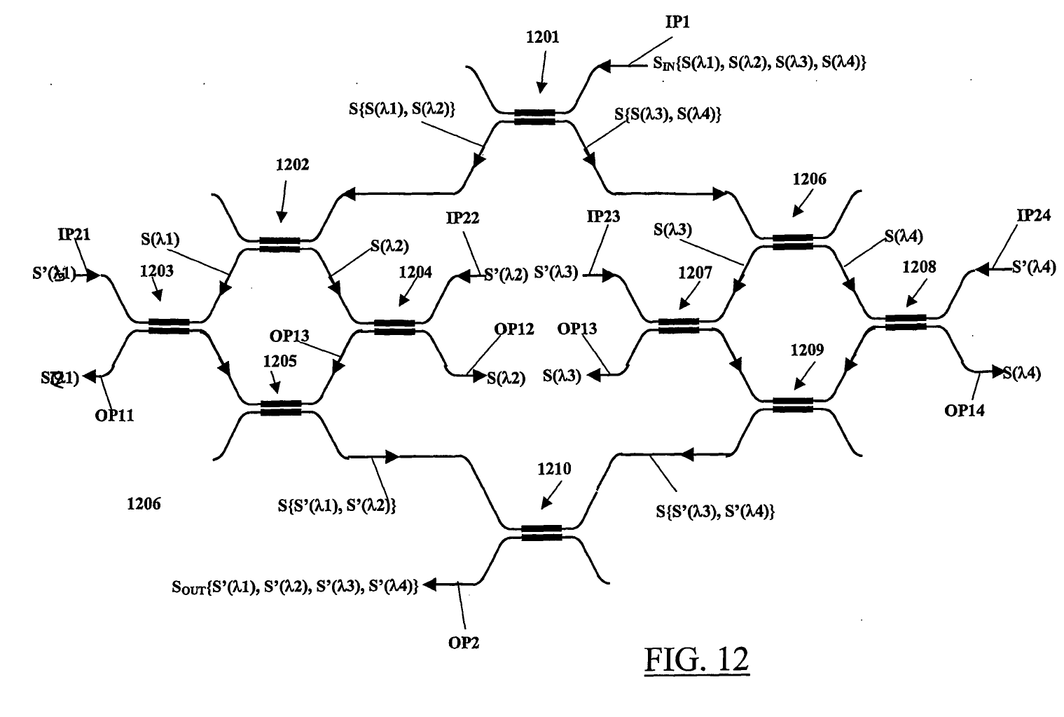

FIG. 12 is a schematic view of the four-channel optical add/drop device realized according to an alternative embodiment of the present invention; and

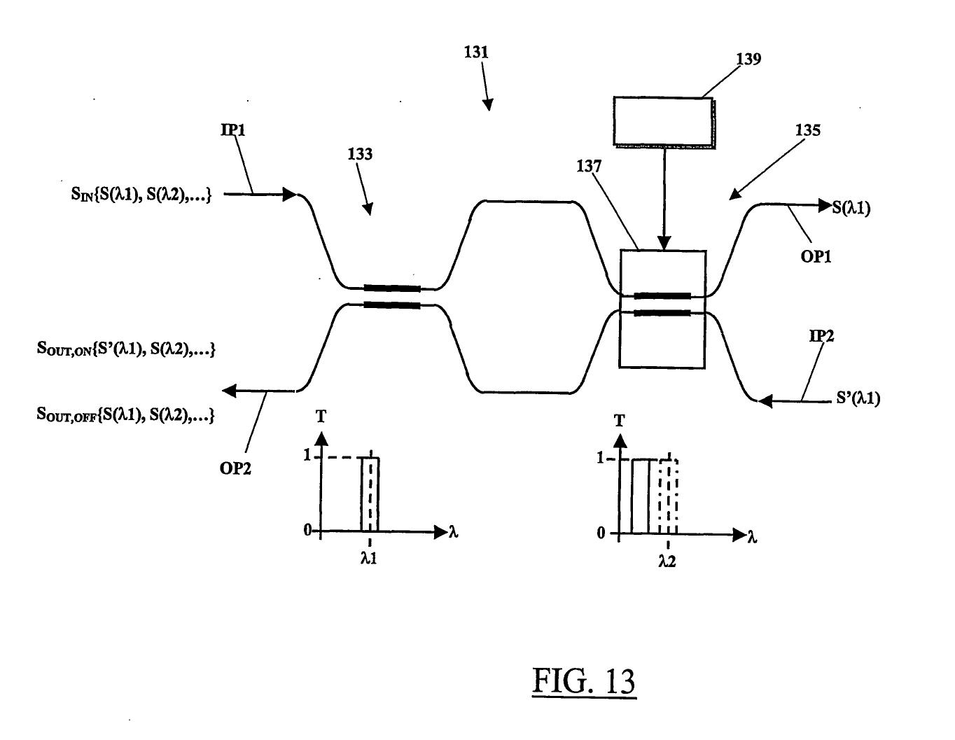

FIG. 13 is a schematic view of another optical device still realized in accordance with the present invention.

With reference to the drawings, and particularly to FIG. 1, a single-channel optical add/drop device 101 is a four-port device with two input ports IP1 and IP2 and two output ports OP1 and OP2. A first input port IP1 receives a wavelength division multiplexed optical signal S_{IN}{S(λ1), S(λ2), . . . } made up of a plurality (two or more) of optical signals S(λ1), S(λ2), . . . . Each of the signals S(λ1), S(λ2), . . . is associated with a respective wavelength band (also referred to as a channel) centered on a respective wavelength λ1, λ2, . . . (also referred to as the channel central wavelength). For example, considering the case of a four-channel CWDM transmission, the channel central wavelengths are 1470 nm, 1490 nm, 1510 nm and 1530 nm.

One of the signals, namely the signal S(λ1) in the shown example (with, e.g., λ1=1490 nm), is extracted (dropped) from the multiplexed optical signal S_{IN}{S(λ1), S(λ2), . . . } and made available at a first output port OP1 of the add/drop device 101; the dropped signal S(λ1) can thus be routed to the prescribed recipient, for example a user home appliance such as a television set, a telephone set, a personal computer and the like, wherein the optical signal is transformed into a corresponding electrical signal by means of a photodetector (not shown). A second input port IP2 of the add/drop device 101 is adapted to receive an optical signal S′(λ1), generated for example by a laser source and centered on the same wavelength λ1 as the dropped signal S(λ1); the signal S′(λ1) is added to the remaining signals S(λ2), . . . , and a new multiplexed signal S_{OUT}{S′(λ1), S(λ2), . . . } resulting from the combination of the original signals S(λ2), . . . not dropped, and the added signal S′(λ1) is made available at a second output port OP2 of the add/drop device 101.

FIG. 2 schematically shows the single-channel add/drop device 101 realized according to an embodiment of the present invention. The device includes an optical directional coupler. The coupler comprises a first optical waveguide 201 and a second optical waveguide 203, arranged so as to be in optical coupling relationship in an optical coupling region 205, wherein respective sections 201a, 203a of the waveguides 201, 203 are in close proximity to each other.

In the optical coupling region 205, an optical signal propagating through one of the two waveguides, e.g. the waveguide 201, is coupled into the other waveguide 203 and the power of the signal is split. Depending on the length of the optical coupling region in the light propagation direction, different optical power split ratios can be obtained. In particular, a coupler is commonly defined “half-cycle” if the length of the coupling region 205 is such that the whole optical power of a signal propagating through one of the two waveguides is coupled into the other waveguide; a coupler is instead defined “full-cycle” if the length of the coupling region 205 is such that the whole optical power of a signal propagating through one of the two waveguides is coupled again into such a waveguide. The coupling region is shorter in a half-cycle coupler than in a full-cycle coupler; this means that a half-cycle coupler is more compact than a full-cycle coupler. Additionally, since the bandwidth of the coupler decreases with the increase in the coupler length, a half-cycle coupler has a wider bandwidth compared to a full-cycle coupler.

According to an embodiment of the present invention, the coupler is a half-cycle coupler. An end 207 of the first waveguide 201, adjacent a first side of the coupling region 205, forms the first input port IP1 of the add/drop device; an opposite end 209 of the first waveguide 201, adjacent a second side of the coupling region 205 opposite the first side, forms the second input port IP2. A first end 211 of the second waveguide 203, adjacent the second side of the coupling region 205, forms the first output port OP1 of the add/drop device; an opposite end 213 of the second waveguide, adjacent the first side of the coupling region 205, forms the second output port OP2.

In accordance with an embodiment of the present invention, the coupler is formed as a monolithic device, integrated in a chip schematically shown in FIG. 2 and denoted therein by 221, and the optical waveguides 201 and 203 are integrated planar waveguides; in particular, the waveguides 201 and 203 may be buried waveguides, ridge waveguides or raised strip waveguides. FIG. 3 shows a schematic cross-sectional view of the coupler along the plane III-III, in the exemplary case of buried waveguides, particularly silica buried waveguides. The structure comprises a substrate 301, for example of a semiconductor material such as silicon. Alternatively, the substrate 301 can be made of a dielectric material, a magnetic material or glass.

A lower cladding layer 303 is formed on the substrate 301. The lower cladding layer 303 is for example made of silica. The cores of the waveguides 201 and 203 are formed by strips of a layer 305 of doped silica; the strips of doped silica layer 305 are immersed in a first upper cladding layer 307 made for example of silica. The first upper cladding layer 307 is covered by a second upper cladding layer 309, of the same material as the first upper cladding layer. Optical signals are guided by the waveguide cores because of the difference in the refractive indexes of the doped silica layer 305, having in particular a higher refractive index, and the lower and the first upper cladding layer 303 and 307, having a lower refractive index. Given a refractive index contrast between the waveguide cores and the cladding layers, the dimensions of the waveguide cores are chosen in such a way to have single-mode waveguides; the thickness of the cladding layers are chosen to reduce the losses, and in particular the thickness of the lower cladding layer is such as to decouple the propagating mode from the substrate. Referring back to FIG. 2, along each of the waveguide sections 201a and 203a, a respective Bragg grating 215 and 217 is formed. The Bragg gratings 215 and 217 are designed to have an optical response such that a signal in the channel band centered on a prescribed wavelength, in the example the wavelength λ1 (e.g., 1490 nm) can be separated from the signals in the other channel bands, centered on the wavelengths λ2, . . . (e.g., 1470 nm, 1510 nm and 1530 nm). In particular, The Bragg gratings 215 and 217 have an optical response such that a signal in the band centered on the wavelength λ1 passes substantially unattenuated through the gratings, while the remaining signals are substantially completely reflected.

In particular, as visible in FIG. 4, the Bragg gratings 215 and 217 are formed by providing a longitudinal succession of trenches or gaps 401 along each section 201a and 203a of the waveguides 201 and 203. The gaps 401 extend from the top surface of the first upper cladding layer 307 down through the doped silica layer 305 and partially into the lower cladding layer 303. Each Bragg grating 215, 217 thus comprises gaps 401 alternated to portions 403 of the respective waveguide core. The gaps 401 may be filled with a fluid, such as air, gas or a liquid, or with other materials, such as glasses or oxides having a desired refractive index, or they may be emptied to create vacuum thereinside. The second upper cladding layer 309 seals the top free open side of the gaps 401.

The alternation of gaps 401 and portions 403 of the waveguide core forms a structure having a modulated refractive index, capable of performing a filtering in the wavelength domain.

A gap 401 followed, in the propagation direction of the optical signals, by an adjacent waveguide portion, comprised of a portion 403 of the waveguide core and the associated portions of the lower and upper cladding, form an elemental unit of the modulated refractive index structure, and particularly an elemental unit of the Bragg gratings; such an elemental unit will be hereinafter referred to as a cell; in FIG. 4 only two cells C of the Bragg grating 225 are shown, for simplicity.

A cell has a spectral response determined by the overall dimension of the cell in the light propagation direction (d1+d2 in FIG. 4), and by the ratio between the dimensions d1 and d2 (taking account of the respective refractive indexes).

Let n₁ and n₂ be the refractive indexes of the two regions of the cell, namely the gap 401 and the adjacent waveguide portion; it is intended that n₁ and n₂ are the effective indexes for the propagating mode.

Assuming first that the difference between n₁ and n₂ is small (as in low refractive index contrast structures), it can be shown that a cell is transmissive (i.e., a propagating mode of wavelength λ pass through the cell) if
(n₁d1+n₂d2)=m(λ/2)+λ/4
while the cell is reflective (the propagating mode is reflected) if
(n₁d1+n₂d2)=m(λ/2)
where m is a positive integer, commonly referred to as the order of the cell.

Once the dimension d1 is chosen, these two equations allow determining the dimension d2 so that the cell is transmissive or reflective:
transmissive cell: d2=(2m+1)(λ/4n₂)−d1(n_{1/}n₂)
reflective cell: d2=m(λ/2n₂)−d1(n₁/n₂).

The Applicant has however observed that these formulas are the result of an approximation, based on the assumption that the refractive index contrast is low. These formulas cannot be applied in the case the difference between n₁ and n₂ is not small, as in high refractive index contrast structures. The Applicant has therefore derived exact conditions that are valid also in the case the difference between n₁ and n₂ is high. In particular, the conditions under which a cell is transmissive are:
d1=m(λ/2n₁) (1)
or
d2=(λ/2πn₁)(mπ+α) (2)
where α is a correction factor given by:
α=arc tan{[(1−ρ²)cos φ₂]/[(1+ρ²)cos φ₂]};
ρ is the field reflectivity at the interface between the two regions of different refractive indexes of the cell, and φ₂ is the phase contribution due to the propagation within the region of dimension d2 of the cell.

It can be appreciated that if d1 is chosen to be equal to an integer multiple of half a wavelength of the propagating mode (equation (1)), the cell results to be transmissive irrespective of the value of d2. For values of d1 different from an integer multiple of half a wavelength of the propagating mode, the cell result to be transmissive if d2 is chosen according to the equation 2), while the cell result to be reflective if d2 is chosen according to the following equation:
d2=(λ/2πn₁)[(m−½)π+α] (3).

Using a high refractive index contrast Bragg grating, and properly dimensioning the cells so as to result reflective at a desired wavelength, it is possible to obtain an optical filter adapted to reflect optical signals with wavelengths within a prescribed, relatively wide band (reflection band or stop band) centered on the desired wavelength. A relatively small number of reflective cells is sufficient for achieving a relatively wide stop band and an approximately 100% reflectivity within such a band. On the contrary, this result cannot be achieved using low refractive index contrast Bragg gratings, because even for large number of reflective cells the width of the stop band would be very limited, and the reflectivity within such a band would not reach 100%.

Defining the refractive index contrast between the two regions of a cell as Δn=100×(n₂/n₁−1) [%], for the purposes of the present invention a high refractive index contrast means Δn>1.5%.

In the present case, if the filler of the gaps 401 is chosen in such a way to have a refractive index significantly different from that of the doped silica layer 305, a high refractive index contrast Bragg filter can be obtained. A typical refractive index value of a waveguide core made of doped silica is approximately 1.45 at a wavelength of approximately 1500 nm, while a gap 401 filled with air has a refractive index approximately equal to 1 at that wavelength; the refractive index contrast is thus equal to approximately 45%, i.e., the Bragg grating thus obtained forms a filter having a high refractive index contrast. Other materials can of course be used to fill the gaps 401, which still allow to obtain a high refractive index contrast structure.

If, among a plurality of cells reflective at the desired stop band central wavelength, at least one cell is placed that is dimensioned to be transmissive at a desired pass band central wavelength within the stop band, it is possible to obtain an optical filter adapted to reflect optical signals with wavelengths within the stop band, at the same time capable of transmitting optical signals with wavelengths within a prescribed, relatively narrow pass band centered on the pass band central wavelength.

In particular, the stop band may be chosen to extend over the whole spectrum region occupied by a wavelength division multiplexed signal having a prescribed number of channels, and the pass band may be chosen to correspond to one or more of the channels of the wavelength division multiplexed signal, with the pass band central wavelength substantially coincident with the respective channel central wavelength.

Although in principle just one transmissive cell, properly dimensioned and inserted among the plurality of reflective cells, is sufficient to create a pass band within the stop band, the Applicant has observed that the lorentzian shape of the resulting pass band is not suitable for practical applications in the field of optical communications, due to the narrowness of the pass band at high transmittivity values, and its slow extinction. The Applicant has observed that a larger and flatter pass band, with faster extinction rate out of the desired wavelength range can be obtained by providing more than just one transmissive cell, distributed among the reflective cells.

In addition, the Applicant has found that even better results in terms of pass band flatness are obtained if the number of reflective cells placed between consecutive transmissive cells, and/or the dimensions of the transmissive cells are properly chosen.

For example, referring to FIG. 5, there is schematically shown, in cross-sectional view similar to that of FIG. 4, a Bragg grating structure according to an embodiment of the present invention (also referred to as an apodized Bragg grating structure). The grating comprises a plurality of trenches or gaps 401, defining a plurality of cells C1-C15 (fifteen in the shown example). The dimensions of the cells C1-C15 are such that some cells, particularly the cells C2, C3, C5, C6, C7, C9, C10, C11, C13 and C14 (denoted as R in the drawing) are reflective at the wavelength λ_{SB} (FIG. 6), while some other cells, particularly the cells C1, C4, C8, C12 and C15 (denoted as TX) are transmissive at the wavelength λ_{PB}=λ1 that, in the particular example here considered, corresponds to λ_{PB}.

In the shown embodiment, the different spectral behaviour of the reflective and transmissive cells is achieved by acting (varying) the dimension of the portions 403 of waveguide core in the cells, while the dimension of the gaps 401 is kept constant and equal to d1. In particular, given the dimension d1, the dimensions of the portions 403 of waveguide core in the cells are determined on the basis of the equations (2) and (3) reported previously. In the shown example, the dimension of the portion 403 of waveguide core in all the reflective cells C2, C3, C5, C6, C7, C9, C10, C11, C13 and C14 is set equal to d21, and the dimensions of the portion 5403 of waveguide core in the transmissive cells C1, C4, C8, C12 and C15 are chosen in such a way that the dimension of the portion 403 of waveguide core in the first and the fifth transmissive cells C1 and C15 has a first value d22, the dimension of the portion 403 of waveguide core in the second and the fourth transmissive cells C4 and C12 has a second value d23 lower than the first value d22, and the dimension of the portion 403 of waveguide core in the third transmissive cell C8 has a third value d24 higher than the first value d22.

In the exemplary Bragg grating shown FIG. 5, not only are the dimensions of the transmissive cells varied in the light propagation direction, but also the number of reflective cells between adjacent transmissive cells varies. In particular, two reflective cells are placed between the first two transmissive cells, three reflective cells are placed between the second two transmissive cells and between the third two transmissive cells, and two reflective cells are placed between the last two transmissive cells.

More generally, it, can be observed that a transmissive cell constitutes a sort of defect in a regular structure comprising only reflective cells; such a defect, together with the adjacent reflective cells, acts like a Fabry-Perot resonant cavity with mirrors represented by the reflective cells adjacent the transmissive cells; the light stays in such a cavity for a time related to the cavity length (i.e., the dimension of the transmissive cell) and the mirror reflectivity related to the number of adjacent reflective cells. In order to have a flat pass band, the dimensions of the transmissive cells and the distribution of reflective cells among the transmissive cells shall be such that the distribution of the times of permanence of the light in the cavities is substantially gaussian, with a maximum located substantially at the center of the whole structure. This can be achieved by varying the number of reflective cells (keeping the dimensions and the number of the transmissive cells fixed), so that the reflective cells increase in number in the first half of the grating in the light propagation direction, while they decrease in number in the second half of the grating; in particular, the distribution of reflective cells in the second half of the grating can be generically symmetric to the distribution of reflective cells in the first half of the grating. Alternatively, the number of reflective cells between adjacent transmissive cells can be kept constant, and the dimensions of the transmissive cells be increased towards the center of the grating. In still another alternative, both the transmissive cell dimensions and the number of reflective cells between adjacent transmissive cells can be varied as described above.

In the example of FIG. 5, the number of reflective cells increases towards the centre of the grating, while the dimension of the transmissive cells first decreases and then increases.

Based on the previous considerations, Bragg gratings 215, 217 can be formed constituting a band-pass filters having a stop band (SB in FIG. 6) spanning the wavelength range of the wavelength division multiplexed signal, and a pass band (PB1 or PB2 in FIG. 6) corresponding to one of the channels of the wavelength division multiplexed signal. Optical signals with wavelengths falling within the pass band can pass through the grating substantially unattenuated, while optical signals with wavelengths falling within the stop band are reflected. For example, FIG. 6 schematically shows the optical response of Bragg gratings adapted to be used in the context of CWDM optical communications, designed to have a stop band SB of approximately 90 nm centered on a central stop band wavelength λ_{SB} of approximately 1490 nm, and a pass band PB1 or PB2 (of approximately 20 nm) centered on a desired pass band central wavelength λ1 or λ2 (1490 or 1470 nm).

The Applicant designed an integrated optical device of the type shown in FIG. 2. The thickness of the silica layer forming the lower cladding layer 303 was in the range 10-20 μm; the thickness and width of the doped silica layer forming the waveguide cores 305 was approximately 4-5 μm; the thickness of the silica layer forming the first upper cladding layer 307 was approximately 10 μm; and the thickness of the silica layer forming the second upper cladding layer 309 was approximately 10 μm. The waveguide cores had a refractive index of 1.454, and the cladding layers had a refractive index of 1.444. The gaps 401 were filled with air. Bragg gratings having each an overall length of 68.39 μm were formed along the two waveguide sections 201a, 203a, with gaps 401 of 500 nm; the length of the waveguide core 305 sections in the reflective cells was 1.714 μm, the length of the waveguide core sections in the transmissive cells C1 and C15 was 8.648 μm, the length of the waveguide core sections in the transmissive cells C4 and C12 was 7.621 μm, and the length of the waveguide core sections in the transmissive cell C8 was 10.702 μm. Experiments conducted on such a grating structure showed that the gratings provided a quite flat pass band centered on a wavelength of 1490 nm, with rather steep edges. These Bragg gratings are suitable for separating the channel centered on the wavelength λ1 (1490 nm), from the remaining channels of a coarse wavelength division multiplexed signal.

A process for the manufacturing of an add/drop device according to an embodiment of the present invention will be now described. In particular, the process that will be described by way of example refers to the manufacturing of a silica buried waveguide device.

Firstly, the silica layer 303 that will form the lower cladding layer is formed on the silicon substrate 301; in particular, the layer 303 can be formed by deposition, by means of conventional deposition techniques such as the Chemical Vapour Deposition (CVD), the Flame Hydrolysis Deposition (FHD) or the electron-beam deposition.

Then, the doped silica layer 305 is formed on the lower cladding layer 303, for example by means of any one of the cited deposition techniques. The doping of the layer is achieved by introducing into the reaction chamber the desired dopants; for example, a germanium-doped silica layer can be obtained by mixing SiCl₄ and GeCl₄.

The doped silica layer 305 must then be patterned to define the cores of the two waveguide 201 and 203. This can be achieved by means of photolithographical techniques: a layer of a photosensible resin (photoresist) is deposited on the layer 305, and the photoresist layer is then selectively exposed to radiation (typically, UV light) through a suitable mask. The areas of the photoresist that have been exposed to the radiation are then removed. By means of an etching process, uncovered areas of the doped silica layer 305 are then removed, to define the waveguide cores; the etching process is preferably anisotropic (e.g., Reactive Ion Etching—RIE). After the etching, the photoresist is completely removed.

The first upper cladding layer 307 is then formed on the structure, for example by means of any of the cited deposition techniques.

In this way, a structure including the two buried waveguides 201 and 203 is obtained.

The two Bragg gratings 215, 217 are then formed along the two sections 201a, 203a of the waveguides in the coupling region 205. Similarly to the definition of the waveguide cores, this is achieved by means of photolithographic techniques. A mask layer is first deposited on top of the first upper cladding layer 307. FIGS. 7 and 8 schematically show, respectively in top-plan view and in cross-section along the waveguide section 201a, a portion of the device with the mask layer applied. Reference numeral globally 701 denotes the mask layer. It can be seen that generically rectangular windows 703 are formed in the mask layer 701, said windows extending transversally to the waveguide sections 201a and 203a. A following etching process allows removing the first upper cladding layer 307, the doped silica layer 305 forming the two waveguide cores and part of the lower cladding layer 303 in correspondence of the rectangular gaps in the mask layer 701. In this way, trenches defining the gaps 401 schematically shown in FIG. 4 are formed. In particular, the gaps 401 preferably have a depth that depends on the mode-field diameter (MFD) of the optical signals; preferably, the depth of the gaps is at least equal to twice the MFD: the Applicant has found that in this way the transmittivity is not significantly affected. The etching process is anisotropic, due to the relatively small aspect ratio of the gaps 401 to be formed. Preferably, the etching process is anisotropic, due to the relatively small aspect ratio of the gaps 401 to be formed.

After this step, the mask layer 701 is removed, and the second upper cladding layer 309 is formed on top of the structure, so as to seal the gaps 401.

It is observed that by means of the process described, the two Bragg gratings are formed simultaneously and can easily be made identical to each other, as well as located substantially at a same longitudinal position along the two waveguide sections 201a and 203a.

The operation of the add/drop device shown in FIG. 2 will be now explained making reference to the schematic views of FIGS. 9A and 9B. In this drawings, L_{c} denotes the length of the coupling region 205, L_{50%} denotes the distance from the first side of the coupling region at which a 50% of optical power coupling takes place, and Lₘ denotes the distance, from the beginning of the Bragg gratings 215, 217, at which a grating equivalent mirror is located. The grating equivalent mirror is an ideal mirror, equivalent to the grating as far as reflectivity is concerned, located in a prescribed position along the grating.

When the multiplexed signal S_{IN}{S(λ1), S(λ2), . . . }, entering the device from the first input port IP1 and propagating through the first waveguide 201, reaches the coupling region 205, a transfer of optical power between the two waveguides takes place; in particular, at the distance L_{50%} from the first side of the coupling region, 50% of the optical power is present on each of the two waveguides. If the grating equivalent mirrors are properly located at the distance L_{50%} from the first side of the coupling region, only the signal in the wavelength band centered on the wavelength λ1 is transmitted, the remaining multiplexed signals (centered on the wavelengths λ2, . . . ) being reflected. In the propagation through the coupling region 205 towards the second side thereof, the transmitted signal is further subjected to optical power transfer between the two waveguides, and the full-power signal S(λ1), dropped from the original multiplexed signal S_{IN}{S(λ1), S(λ2), . . . }, is made available at the first output port OP1 of the device (FIG. 9B). The reflected signal, propagating through the coupling region back towards the first side thereof, is also further subjected to an optical power transfer between the two waveguides, and a full-power multiplexed signal S_{OUT}{S(λ2), . . . } is made available at the second output port OP2 of the device (FIG. 9A).

The device also allows adding a new signal S′(λ1), centered on the same wavelength λ1 as the dropped signal S(λ1), to the multiplexed signal S_{IN}{S(λ²), . . . }, thereby obtaining the new multiplexed output signal S_{OFF}{S′(λ1), S(λ2), . . . }. If the new signal S′(λ1) is fed to the second input port IP2 of the device (FIG. 9B) and propagated through the first waveguide 201, when such a signal reaches the optical coupling region 205 a transfer of optical power between the two waveguides takes place; the signal is transmitted by the Bragg gratings 215 and 217, and a full-power signal S′(λ1) is made available at the second output port OP2 of the device. This signal, together with the multiplexed signal S_{IN}{S(λ²), . . . }, forms the new multiplexed output signal S_{OUT}{S′(λ1), S(λ2), . . . }.

It can be appreciated that the in the described device the angle of incidence of the optical signals onto the gratings is always substantially equal to zero. This is a significant feature, because the problems inherent to a tilted incidence of the signals onto the gratings are thus avoided. In particular, the filtering characteristics of the Bragg gratings are not degraded, and no power losses are incurred.

It is observed that in order to achieve the desired result, it is important that the two Bragg gratings 215 and 217 are positioned along the respective waveguide sections 201a and 203a in such a way that the grating equivalent mirror is located substantially where the optical coupling ratio is equal to 50%; in this way, the full power of the optical signal which is reflected by the grating 215 in the first waveguide 201 is transferred to the second waveguide 203 during the propagation back towards the first side of the coupling region 205, so that the full power of the optical signal S_{IN}{S(λ2), . . . } entering the first input port IP1 if the device is transferred to the second output port OP2.

Positioning the grating equivalent mirror in correspondence of the point at which the coupling ratio is equal to 50% is facilitated using a high refractive index contrast Bragg grating, since in this case the overall grating length is substantially smaller than the length L_{c} of the coupling region 205: the whole grating can be placed in a small region around the point at which the coupling ratio is equal to 50%.

It is worth noting that the adoption of high refractive index contrast Bragg gratings allows forming optical filters capable of transmitting signals with wavelengths in a selected, narrow band (pass band), and reflecting signals with wavelengths outside the pass band. This allows forming an add/drop multiplexer in which the dropped signal and the added signal are transmitted by the grating (drop and add in transmission). On the contrary, low refractive index contrast Bragg gratings feature an opposite behaviour, being capable of reflecting optical signals with wavelengths in a selected band, and transmitting signals with different wavelengths; using low refractive index contrast gratings, it would only be possible to form an add/drop multiplexer in which the dropped signal and the added signal are reflected (drop and add in reflection). Due to this, the position of the Bragg grating should be optimised for reflection of signals entering the coupling region from both of the sides thereof, which is not feasible using a half-cycle coupler. In fact, while in a half-cycle coupler the 50% optical power transfer point is unique, in a low refractive index Bragg grating two separated equivalent mirrors are identified, which are located relatively close to the grating end sections. The two equivalent mirrors cannot be both positioned at the 50% optical power transfer point. Additionally, a low refractive index contrast grating is normally rather long, and particularly the overall grating length is comparable to the length of the coupling region. Thus, should a low refractive index contrast Bragg grating be adopted, a full-cycle coupler were to be used, with a negative impact on the structure compactness and bandwidth.

The deeply-etched grating structure described herein, with deep trenches formed in the waveguides, allows obtaining high refractive index contrast gratings, and manufacturing processes can be devised such that the gratings are identical to each other and identically located along the respective waveguide sections.

By combining a plurality of single-channel add/drop devices of the type shown in FIG. 2, a monolithic multi-channel add/drop device can be obtained. For example, FIG. 10 is a symbolic representation of a four-channel add/drop device; the device comprises an input port III adapted to receiving a four-channel wavelength division multiplexed signal S_{IN}{S(λ1), S(λ2), S(λ3), S(λ4)}, four output ports (drop ports) OP11 to OP14, each one delivering a respective one of the four signals S(λ1), S(λ2), S(λ3), S(λ4) composing the four-channel signal S_{IN}{S(λ1), S(λ2), S(λ3), S(λ4)}, four input ports (add ports) IP21 to IP24, each one adapted to receiving a respective new signal S′(λ1), S′(λ2), S′(λ3), S′(λ4) centered on a prescribed one of the four wavelengths λ1 , λ2, λ3, λ4; and an output port OP2 delivering a new four-channel wavelength division multiplexed signal S_{OUT}={(S′(λ1), S′(λ2), S′(λ3), S′(λ4)} resulting from the combination of the four signals S′(λ1), S′(λ2), S′(λ3), S′(λ4).

FIG. 11 schematically shows a four-channel add/drop device realized according to an embodiment of the present invention. The device comprises four single-channel add/drop devices 1011, 1012, 1013, 1014 of the type shown in FIG. 2, connected in cascade to each other. A first add/drop device 1011 receives the original four-channel multiplexed signal S_{IN}{(S(λ1), S(λ2), S(λ3), S(λ4)}, drops therefrom the signal S(λ1), and adds thereto the signal S′(λ1), delivering a new four-channel multiplexed signal S{S′(λ1), S(λ2), S(λ3), S(λ4)} to a second add/drop device 1012; the second add/drop device 1012 drops from the multiplexed signal S{S′(λ1), S(λ2), S(λ3), S(λ4)} the signal S(λ2) and adds thereto the signal S′(λ2), delivering a new four-channel multiplexed signal S{S′(λ1), S′(λ2), S(λ3), S(λ4)} to a third add/drop device 1013; the third add/drop device 1013 drops from the multiplexed signal S{S′(λ1), S′(λ2), S(λ3), S(λ4)} the signal S(λ3) and adds the signal S′(λ3), delivering a new four-channel multiplexed signal S{S′(λ1), S′(λ2), S′(λ3), S(λ4)} to a fourth add/drop device 1014; finally, the fourth add/drop device 1014 drops the signal S(λ4) from the multiplexed signal S{S′(λ1), S′(λ2), S′(λ3), S(λ4)} and adds thereto the signal S′(λ4), thereby delivering at the output port OP2 of the device the output four-channel multiplexed signal S_{OUT}{S′(λ1), S′(λ2), S′(λ3), S′(λ4)}.

An alternative embodiment of a four-channel add/drop device is schematically depicted in FIG. 12. The device comprises ten add/drop devices 1201-1210 of the type shown in FIG. 2, connected in a tree configuration. An input port of a first add/drop device 1201 receives the four-channel multiplexed input signal S_{IN}{S(λ1), S(λ2), S(λ3), S(λ4)}. The device 1201 has Bragg gratings 215, 217 designed in such a way as to allow separating pairs of signals S(λ1), S(λ2) and S(λ3), S(λ4); in particular, the signals S(λ1), S(λ2) pass through the gratings, and a multiplexed signal S{S(λ1), S(λ2)} is made available at a first output port of the device 1201, while the signals S(λ3), S(λ4) are reflected, and a multiplexed signal S{S(λ3), S(λ4)} is made available at the second output port of that device.

The signal S{S(λ1), S(λ2)} is fed to a first input port of a second add/drop device 1202; this device is designed to allow separating the signals S(λ1), S(λ2): the signal S(λ1) passes through the gratings and is made available at a first output port of the device 1202, while the signal S(λ2) is reflected and made available at a second output port of the device 1202. The signal S(λ1) is then fed to a first input port of a third add/drop device 1023, designed to have a pass band centered on the wavelength λ1; the signal S(λ1) is made available at a first output port of the device 1203. A new signal S′(λ1), in the same wavelength band as the signal S(λ1), is fed to a second input port of the device 1203; the signal S′(λ1) passes through the gratings and is made available at the second output port of the device 1203. Symmetrically, The signal S(λ2) is fed to a first input port of a fourth add/drop device 1024, designed to have a pass band centered on the wavelength λ2; the signal S(λ2) pass through the gratings and is made available at a first output port of the device 1204. A new signal S′(λ2), in the same wavelength band as the signal S(λ2), is fed to a second input port of the device 1204; the signal S′(λ2) passes through the gratings and is made available at the second output port of the device 1204. The signals S′(λ2) and S′(λ1) are respectively fed to a first and a second input ports of a fifth add/drop device 1205, designed to have a pass band centered on the wavelength λ1; the signal S′(λ2) is reflected by the gratings, while the signal S′(λ1) passes through the gratings, and a multiplexed signal S{S′(λ1), S′(λ2)} composed of both these signals is made available at a second output port of the device 1205.

Symmetrically, the signal S{S(λ3), S(λ4)} is fed to a first input port of a sixth add/drop device 1206, designed to allow separating the signals S(λ3), S(λ4); the signal S(λ4) passes through the gratings and is made available at a first output port of the device 1206, while the signal S(λ3) is reflected by the gratings and is made available at a second output port of the device 1206. The signal S(λ3) is then fed to a first input port of a seventh add/drop device 1027, designed to have a pass band centered on the wavelength λ3; the signal S(λ3) passes through the gratings and is made available at a first output port of the device 1207. A new signal S′(λ3), in the same wavelength band as the signal S(λ3), is fed to a second input port of the device 1207; the signal S′(λ3) passes through the gratings and is made available at the second output port of the device 1207. Symmetrically, the signal S(λ4) is fed to a first input port of an eight add/drop device 1028, designed to have a pass band centered on the wavelength λ4; the signal S(λ4) is made available at a first output port of the device 1208. A new signal S′(λ4), in the same wavelength band as the signal S(λ4), is fed to a second input port of the device 1208; the signal S′(λ4) passes through the gratings and is made available at the second output port of the device 1208. The signals S′(λ3) and S′(λ4) are respectively fed to a first and a second input ports of a ninth add/drop device 1209, designed to have a pass band centered on the wavelength λ4; the signal S′(λ3) is reflected by the gratings, while the signal S′(λ4) passes through the gratings, and a multiplexed signal S{S′(λ3), S′(λ4)} composed of both these signals is made available at a second output port of the device 1209.

Finally, the multiplexed signals S{S′(λ1), S′(λ2)}0 and S{S′(λ3), S′(λ4)} are respectively fed to a first and a second input ports of a tenth add/drop device 1210, designed to let the signals S′(λ3), S′(λ4) pass through the gratings, while the signals S′(λ1), S′(λ2) are reflected. The device 1210 adds the signal S{S′(λ1), S′(λ2)} to the signal S{S′(λ3), S′(λ4)} and delivers the new four-channel multiplexed signal S_{OUT}{S′(λ1), S′(λ2), S′(λ3), S′(λ4)}.

Other optical device structures, even more complex, can easily be obtained by cascading more single-channel add/drop devices.

FIG. 13 schematically shows another optical device, still according to an embodiment of the present invention, useful for applications in the domain of wavelength division multiplexing optical communications, particularly Dense Wavelength Division Multiplexing (DWDM). In particular, the device, identified globally by 131, is a four-port device, having two input ports IP1 and IP2 and two output ports OP1 and OP2, and comprises two single-channel add/drop devices 133 and 135 of the type shown in FIG. 2, connected in series to each other. A first add/drop device 133 is totally similar to the device of FIG. 2, and has Bragg gratings designed to allow dropping a signal S(λ1) centered on a specified wavelength λ1 from a wavelength division multiplexed signal S_{IN}{S(λ1), S(λ2), . . . } received through the first input port IP1. The second device 135 includes a tuneable Bragg grating filter, whose transmission bandwidth can be shifted in a controlled way on the wavelength axis. The device 131 thus features two operating conditions: a first operating condition, in which the second device 135 is tuned on the same wavelength λ1 as the first device 133, and a second operating condition, in which the second device 135 is tuned on a different wavelength. In the first condition, the device 131 behaves like an add/drop multiplexer, delivering at the first output port OP1 the dropped signal S(λ1), and at the second output port OP2 a new multiplexed signal S_{OUT,ON}{S′(λ1), S(λ2), . . . } that is the combination of the original signal S_{IN}{S(λ1), S(λ2), . . . } less the dropped signal S(λ1), and an added signal S′(λ1) received through the second input port IP2. In the second condition, the second device 135 reflects the signal S(λ1) dropped by the first device 133, so that no signal is made available at the first output port OP1; similarly, no signals can be added, and the signal S_{OUT,OFF}{S(λ1), S(λ2), . . . } delivered at the second output port OP2 is the same original signal S_{IN}N{S(λ1), S(λ2), . . . }. The tuning may be for example a thermal tuning, achieved by a thermal tuning element 137 controlled by a tuning control circuitry 139. By way of example, the thermal tuning element 137 may include electrodes generating heat by the Joule effect. Where the Bragg gratings formed in the device 135 have the apodized structure shown in FIG. 5, the tuning is preferably made selectively only on the transmissive cells. The tunable device 131 is also suitable for compensating manufacturing errors.

Although the present invention has been disclosed and described by way of some embodiments, it is apparent to those skilled in the art that several modifications to the described embodiments, as well as other embodiments of the present invention are possible without departing from the scope thereof as defined in the appended claims.

What is claimed is:

1-23. (canceled)

24. An integrated optical device comprising:
a first and a second integrated waveguides each comprising a core and a cladding, a section of the first waveguide and a section of the second waveguide being arranged so as to be in optical coupling relationship; and
a first and a second modulated refractive index structures, respectively formed along the first waveguide section and the second waveguide section, each modulated refractive index structure comprising at least one pair of regions having a first refractive index n₁ and, respectively, a second refractive index n₂ greater than the first, said regions being adjacent to each other along the respective waveguide section, said regions comprising a portion of the respective waveguide section and a gap extending at least across the entire cross-section of the core of the respective waveguide section, the percentage difference Δn=100×(n₂/n₁−1) [%] between said first and second refractive indexes being greater than 1.5%.

25. The integrated optical device according to claim 24, wherein said percentage difference is greater than 10%.

26. The integrated optical device according to claim 25, wherein said percentage difference is greater than 50%.

27. The integrated optical device according to claim 24, wherein the first and second modulated refractive index structures each comprise a plurality of pairs of regions of mutually different refractive index arranged in succession along the respective waveguide section.

28. The integrated optical device according to claim 27, wherein at least one of said plurality of pairs of regions is a transmissive pair for transmitting optical signals with wavelengths within a prescribed wavelength pass band, the remaining pairs of regions being reflective pairs for reflecting optical signals with wavelengths within a prescribed wavelength stop band containing the pass band.

29. The integrated optical device according to claim 28, wherein said pass band corresponds to at least one prescribed channel of a wavelength division multiplexed signal and said stop band is at least as wide as an overall wavelength spectrum region occupied by the wavelength division multiplexed signal.

30. The integrated optical device according to claim 28, wherein said plurality of pairs of regions comprises two or more transmissive pairs, distributed among the reflective pairs, for transmitting optical signals with wavelengths within a prescribed wavelength pass band, the remaining pairs of regions being reflective pairs for reflecting optical signals with wavelengths within a prescribed wavelength stop band containing the pass band.

31. The integrated optical device according to claim 30, wherein the transmissive pairs have varying optical lengths in the light propagation direction.

32. The integrated optical device according to claim 31, wherein a number of reflective pairs between adjacent transmissive pairs varies along the respective waveguide section.

33. The integrated optical device according to claim 24, wherein the optically coupled waveguide sections of the first and second waveguides have a length such that an optical signal propagating through a first one of the two waveguides is substantially completely transferred to the second waveguide.

34. The integrated optical device according to claim 33, wherein each one of the first and second modulated refractive index structures is positioned along the respective waveguide sections in such a way that an equivalent mirror thereof is located substantially at a position where a factor of optical coupling between the optically coupled waveguide sections is approximately equal to 50%.

35. The integrated optical device according to claim 29, wherein the first waveguide has a first input section, adjacent a first side of the optically coupled waveguide sections, and the second waveguide has a first and a second output sections, respectively, adjacent a second side and the first side of the optically coupled waveguide sections, and the device comprises:
a first optical path from the first input section to the first output section, the first optical path propagating from the first input section to the first output section a first optical signal with wavelength in said pass band; and
a second optical path from the first input section to the second output section, the second optical path propagating from the first input section to the second output section a second optical signal with wavelength in said stop band but outside the pass band.

36. The integrated optical device according to claim 35, wherein the first waveguide further comprises a second input section, adjacent the second side of the optically coupled waveguide sections, and the device further comprises a third optical path from the second input section to the second output section, the third optical path propagating from the second input section to the second output section a third second optical signal with wavelength in said pass band.

37. The integrated optical device according to claim 24, wherein an interface between said regions of mutually different refractive index is arranged orthogonally to the light propagation direction in the respective uncoupled waveguide section.

38. An integrated optical multiplexer/demultiplexer device comprising at least a first and a second integrated optical devices according to claim 36, wherein one among the first and second output sections of the first integrated optical device is connected to one among the first and second input section of the second integrated optical device.

39. The integrated optical multiplexer/demultiplexer device according to claim 38, wherein the second output section of the first integrated optical device is connected to the first input section of the second integrated optical device, the first and second integrated optical devices having differentiated first and second pass bands, corresponding to respective first and second channels of a wavelength division multiplexed optical signal.

40. The integrated optical multiplexer/demultiplexer device according to claim 38, further comprising a first integrated optical device adapted to separate an input wavelength division multiplexed optical signal into two groups of channels adjacent to each other in the wavelength domain, at least one second integrated optical device adapted to extract a signal in a respective channel of a respective one of the two channel groups and add a new signal in the same channel as the extracted signal, and a third integrated optical device for recombining the two channel groups.

41. The integrated optical multiplexer/demultiplexer device according to claim 38, wherein the first output section of the first integrated optical device is connected to the first input section of the second integrated optical device, and the second input section of the first integrated optical device is connected to the second output section of the second integrated optical device, and further comprising a tuning device for varying a pass band of the second integrated optical device in a wavelength range containing a pass band of the first integrated optical device.

42. A process for manufacturing an integrated optical device, comprising:
forming on a substrate a first and a second integrated waveguides each comprising a core and a cladding, a section of the first waveguide and a section of the second waveguide being arranged so as to be in optical coupling relationship;
forming along the first waveguide section and the second waveguide section at least one respective first and second modulated refractive index regions each comprising at least one pair of regions having a first refractive index n₁ and, respectively, a second refractive index n₂ greater than the first, said regions being adjacent to each other along the respective waveguide section,
said forming the at least one pair of regions comprising cutting away a portion of the respective waveguide section for defining a gap between two adjacent portions of the respective waveguide section, said gap extending for at least the entire cross-section of the core of the respective waveguide section; and
making the percentage difference Δn=100×(n₂/n₁−1) [%] between said first and second refractive indexes greater than 1.5%.

43. The processing according to claim 42, wherein said cutting away is performed simultaneously in the first and second waveguide sections.

44. The process according to claim 42, wherein said cutting away comprises using a mask defining a pattern of cuts to be formed in the first and second waveguide sections, and selectively removing the first and second waveguide sections according to the pattern defined by the mask.

45. The process according to claim 42, further comprising filling said gaps with a substance having a refractive index different from that of the waveguide sections.

46. The process according to claim 45, wherein said substance is air.
